(19) United States
(12) Patent Application Publication
(10) Pub. No.: US 2020/0184494 A1
(43) Pub. Date: Jun. 11, 2020

(54) Demand Forecasting Using Automatic Machine-Learning Model Selection

(71) Applicant: Legion Technologies, Inc., Redwood City, CA (US)

(72) Inventors: Thomas Joseph, Atherton, CA (US); Yahya Sowti Khiabani, Fremont, CA (US); Sanish Mondkar, San Francisco, CA (US); Gopal Sundaram, Saratoga, CA (US)

(21) Appl. No.: 16/210,865

(22) Filed: Dec. 5, 2018

(51) Int. Cl. G06Q 30/02; G06Q 10/04; G06K 9/62; G06N 20/00

(52) U.S. Cl. CPC G06Q 30/0202; G06N 20/00; G06K 9/6256; G06Q 10/04

(57) ABSTRACT

Disclosed is a system for forecasting demand for goods and/or services. In at least certain embodiments the system is configurable to select a machine learning model from among multiple different machine learning models for forecasting demand for a dataset that may be continually being updated over time. The models available to the system are each based on different machine learning algorithms (e.g., linear regression, gradient boosting, neural network, etc.) as well as several variations for each algorithm available to the system. The system can monitor changes in the datasets, changes in accuracy of the machine learning results, and external factors, and based thereon, determine whether to initiate a model reselection process or a model retraining process. Each machine learning model can be evaluated against each dataset and can select the best model for the dataset.

### BACKGROUND

### Technical Field

Embodiments described in this disclosure relate generally to machine learning techniques for forecasting demand for products and/or services, and more particularly to improved demand forecasting based on selecting from among a plurality of different machine learning models for forecasting demand.

### Brief Description of the Related Art

Workforce management and planning are significant drivers of profitability for businesses. Accurate forecasting of future demand for specific skill categories is important. But managing a workforce is inefficient and most business (or other entities) are not optimizing their labor—leaving profits on the table. Workloads can vary significantly from time to time and it can be difficult to predict how much labor will be needed in advance. Unforeseen future demand can cause a whole host of costs and inefficiencies. For example, inaccurate forecasting may result in employees with one skill set being underutilized or idled while employees with another skill set find themselves overextended.

In addition, there's often a challenge in meeting both business demand as well as employee satisfaction as it relates to work schedules. Scheduling is often an inexact and time-consuming task where employees may not have the flexibility they would like in managing their own schedules. This can lead to employee dissatisfaction and retention issues. Also the workforce for larger institutions may be constantly changing in skill distribution, work experience, geography, etc.

Conventional workforce management systems suffer from many disadvantages. For instance, conventional systems rely workforce demand-forecasting systems are structured around a single location or entity and cannot integrate generation and management of schedules that take into account a workforce that spans multiple dispersed locations. Conventional systems are typically built around a single forecasting model used for all available datasets which can be problematic for forecasting demand across multiple disparate locations because a single static forecasting model may not be optimized for datasets that vary significantly. A forecasting model which may be optimal for one location and set of data may be woefully inadequate for a different location having a different dataset.

Yet another disadvantage associated with prior approaches is the inability to efficiently generate optimized schedules that also account for employee preferences, availability, skills, experience, performance, role, seniority, and/or part time/full time, etc.

Prior systems thus do not have the flexibility and responsiveness to sufficiently adapt to changing conditions in order to forecast demand. They also do not have the capability for generating realistic scheduling of personnel to meet the dynamic requirements of a typical business.

### SUMMARY

The innovative techniques described in this disclosure are directed to systems, methods and computer-readable media for computing demand forecasts based on machine learning techniques. In one embodiment, the techniques described herein are adapted to select which machine learning model stored on, or accessible by, a system is currently producing the best results for forecasting demand from a plurality of machine learning models available to the system. The best results for forecasting demand for a dataset may be based on the most accurate results for the particular dataset and/or other criteria which can be configured by users.

The forecasted demand can be computed for one or more datasets using the selected machine learning model. The accuracy of the demand forecast provided by the selected machine learning model can thereafter be evaluated. In one embodiment the re-evaluation of the model can be accomplished based on comparing the forecasted demand with the actual demand from historical data to determine how the currently selected model is performing. If the selected model is not performing adequately, the system can be configured to detect this condition and to initiate a retraining process for the selected machine learning model or a reselection process for the machine learning model. The determination as to whether to initiate a model retraining or reselection process may take place, for example, based on the system evaluating the accuracy of the resulting demand forecasts output by the selected machine learning model and/or based on evaluating the model based on other user-configurable criteria.

If the system determines to initiate a retraining process (for example when the accuracy or effectiveness of the demand forecast decreases or begins decreasing), the system can be configured to retrain the currently selected model using at least a subset of the dataset. On the other hand, if the system determines to initiate a model reselection process, the system can be configured to (1) retrain each of the plurality of different machine learning models available to the system using the dataset (or portion thereof), (2) compute a demand forecast for the dataset using each of the different trained machine learning models, (3) evaluate the accuracy of the demand forecast results for the dataset provided by each of the different machine learning models, and (4) select the machine learning model that provides demand forecast results with the highest accuracy and/or that satisfy other user-configurable criteria. The selected machine learning model can then be updated with the newly retrained or reselected machine learning model and the dataset can thereafter be processed using the updated machine learning model.

The aspects, features, and advantages of the disclosed embodiments will become apparent to those of ordinary skill in the art from the following description of specific embodiments in conjunction with the accompanying figures.

### BRIEF DESCRIPTION OF THE DRAWINGS

FIG. 1 depicts a conceptual block diagram of an example embodiment of a platform for forecasting demand using automatic machine learning model selection.

FIG. 2 depicts a chart of many known types of machine learning algorithms.

FIG. 3 depicts a conceptual block diagram of an example embodiment of a system for forecasting demand using automatic machine learning model selection.

FIG. 4A depicts a flow chart of an example embodiment of a process for forecasting demand using automatic machine learning model selection.

FIG. 4B depicts a flow chart of an example embodiment of a process for reselecting a machine learning model for forecasting demand.

FIG. 4C depicts a flow chart of an example embodiment of a process for retraining a machine learning model for forecasting demand.

FIG. 5 depicts an example overview block diagram of a data processing system upon which the embodiments described in this disclosure may be implemented.

### DETAILED DESCRIPTION

Throughout this description numerous details are set forth in order to provide a thorough understanding of the various embodiments in this disclosure, which are provided as illustrative examples so as to enable those of skill in the art to practice the embodiments. It will be apparent to those skilled in the art that the techniques described in this disclosure may be practiced without some of these specific details, or in other instances well-known structures and devices may be shown in block diagram form to avoid obscuring the principles and techniques described in this disclosure. The figures and examples provided in this disclosure are not intended to limit the scope to any single embodiment, as other embodiments are possible by way of interchange of some or all of the described or illustrated elements. Where certain elements of these embodiments can be partially or fully implemented using known components, only those portions of such known components that are necessary for an understanding of the embodiments will be described, and detailed descriptions of other portions of such known components will be omitted so as not to obscure the description.

This disclosure is directed to improved methods, systems and computer readable media for forecasting demand for products and/or services based on selecting from among a set of multiple different machine learning algorithms (e.g., linear regression, gradient boosting, neural network, etc.) that are each adapted for forecasting demand for a dataset. In at least certain embodiments the dataset may be continually updated as additional data is received over one or more networks. The system can automatically select a machine learning model from the multiple different machine learning models for forecasting demand based on one or more criteria which can be configured by users of the system. For example, a system according to the innovative techniques described in this disclosure can be configured to select a machine learning model that provides the best or most optimized demand forecast results for a particular dataset. Thereafter, each machine learning model can be (re-)evaluated against the dataset and the model having the highest accuracy (or that satisfies some other user-configurable criteria) for the dataset can be selected to perform the demand forecasting.

The system can be configured to determine whether to initiate a model retraining process or a model reselection process in response to changed conditions in the dataset, such as when the accuracy of the evaluated model has degraded below a threshold value (that may be user configurable), if new updates to the dataset are received over the network(s), or if new data sources become available on the network(s). Other criteria may be used for determining which machine model to select such as for example the model that is a best fit with a particular dataset based on other factors that may be uniquely configured for each different user environment.

The system can also be configured to constantly process data received over the network in order to forecast demand based on a constantly evolving dataset. In such cases the system can monitor the network for one or more triggering events that may initiate a model reevaluation and retraining or reselection process. The various triggering events can also be configured by users according to their particular system environment and dataset(s). For instance, triggering events may include such things as updates or other changes to the dataset(s), changes in the accuracy of the machine learning results, or when new data sources are added (or removed) on the network(s) that provide data to the system.

For example, the predictions can be computed every 30 minutes. They can be computed not only for different locations, but also for different goods, products and/or services to obtain a plurality of machine learning models for demand forecasting. The framework described herein is adaptable to provide a unique model for each location and each type of data, and to automatically evaluate which is the best model among dozens of available models (for each location/category). Food or beverage orders, mobile orders, in-store orders, different channels, different locations, etc. are some of the examples of the specific categories that can be modeled for forecasting demand.

Within a model there are parameters, which change quite often (via retraining, say weekly). At least certain embodiments are adapted to retrain the machine learning models available to the system and to perform the model selection again to see if there is a better model—maybe things have changed since the last model training or evaluation. This can be accomplished during any user-configurable time interval but can be performed as often as the user wants. There could be several trigger events for retraining the model. It could be actuals from the day before (year before) but it can also be from new sources of data. For instance, actuals may be received hourly, daily, weekly, etc., and so the model can be automatically recomputed in response to such changes. The models used for forecasting can therefore be constantly refined to get an accurate forecast, and in at least certain embodiments this can be configured to happen automatically. The trigger event could also be time based (once a week may be good enough).

It should be noted that in at least certain embodiments the data supplied to the system from one or more different data sources may comprise transaction data. Rapid developments in computer resources have provided businesses in the service industry with the potential to collect and maintain vast historical databases of transaction history. Conventional applications called Enterprise Resource Planning (“ERP”) applications have been developed over the years to generate such data. Examples of such conventional ERP packages include SAP, Baan, PeopleSoft, and others. Accordingly, volumes of historical transaction data are available to those businesses that have archived data produced by various ERP applications. Transaction data related to orders, service requests, and other activities is potentially available.

The described embodiments are not intended to be limited to transaction data as any number of different types of data may be used to forecast demand for the goods, products, and/or service requirements based on any number of user-configurable factors. For instance the system may also be configured to process human resources data. Examples of such human resources data may include employee information (e.g., department, division, location, manager, etc.), change in job information (e.g., title, compensation grade, etc.), personal information (e.g., name, location, contact information, etc.), vacation, sick days, leaves of absence, short-term disability, long-term disability, suspensions, furloughs, termination, performance rating, training completion, career plans, etc. The innovative techniques described herein are applicable to any environment in which there may be varying datasets by time, for example by time of day or day of week. For instance, these techniques are applicable to varying workloads within an enterprise (or other entity) to be staffed with a variable number of personnel.

### Example Systems

Provided below is a description of an example system upon which the embodiments described in this disclosure may be implemented. Although certain elements may be depicted as separate components, in some instances one or more of the components may be combined into a single device or system. Likewise, although certain functionality may be described as being performed by a single element or component within the system, the functionality may in some instances be performed by multiple components or elements working together in a functionally coordinated manner.

In addition, hardwired circuitry may be used independently or in combination with software instructions to implement these techniques. The embodiments are not limited to any specific combination of hardware or software. For example, the described functionality may be performed by custom hardware components containing hardwired logic for performing operations, by general-purpose computer hardware containing a memory having stored thereon programmed instructions for performing operations, or by any combination of computer hardware and programmed components. The embodiments may also be practiced in distributed computing environments, such as in a private or public cloud network, where operations may be performed by remote data processing devices or systems that are in communication with one another through one or more wired or wireless networks.

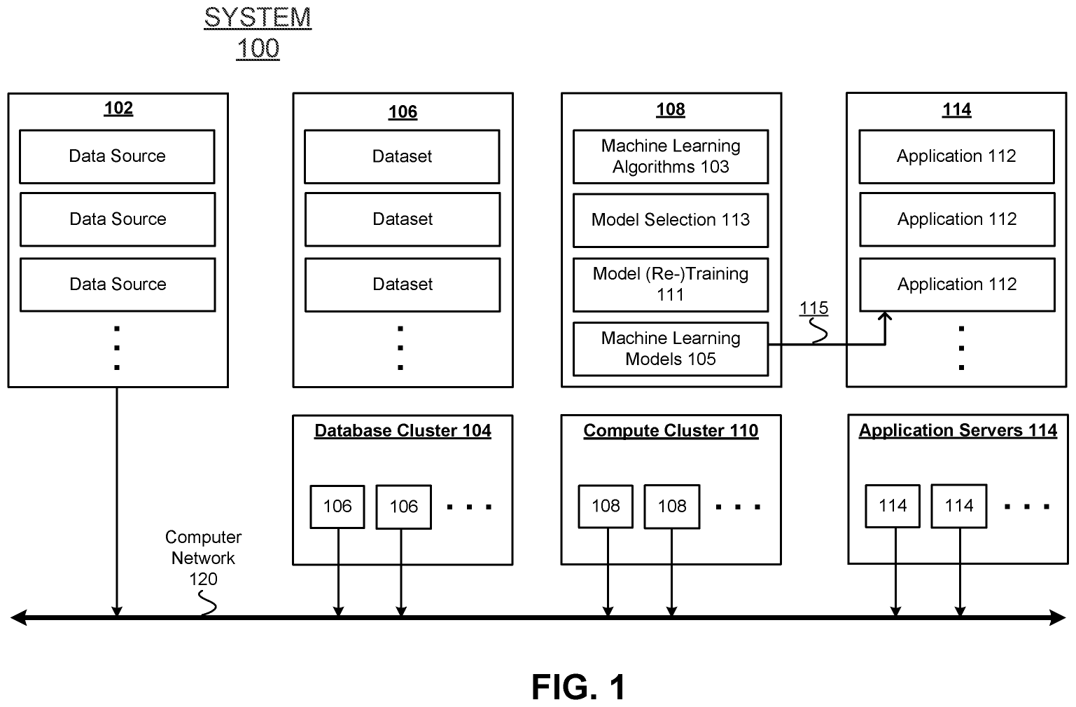

FIG. 1 depicts a conceptual block diagram of an example embodiment of a platform for forecasting demand using automatic machine learning model selection according to the techniques described in this disclosure. System 100 may be optimized for providing demand estimates for goods, products, and/or services, or combination thereof, using the automatic machine learning model selection technique described in this disclosure. Particularly, system 100 can be configured to select an optimal machine learning model from among a plurality of available models on the system to apply to one or more datasets that may be continually changing with time in response to updates in the input data, new sources of input data, and/or other external factors. In at least certain embodiments, the system may be adapted to predict demand drivers for determining the workforce requirements for an entity such as past sales, store traffic, seasonality, weather, nearby events, etc. In other cases, the demand may be forecast for other purposes, such as inventory management for example.

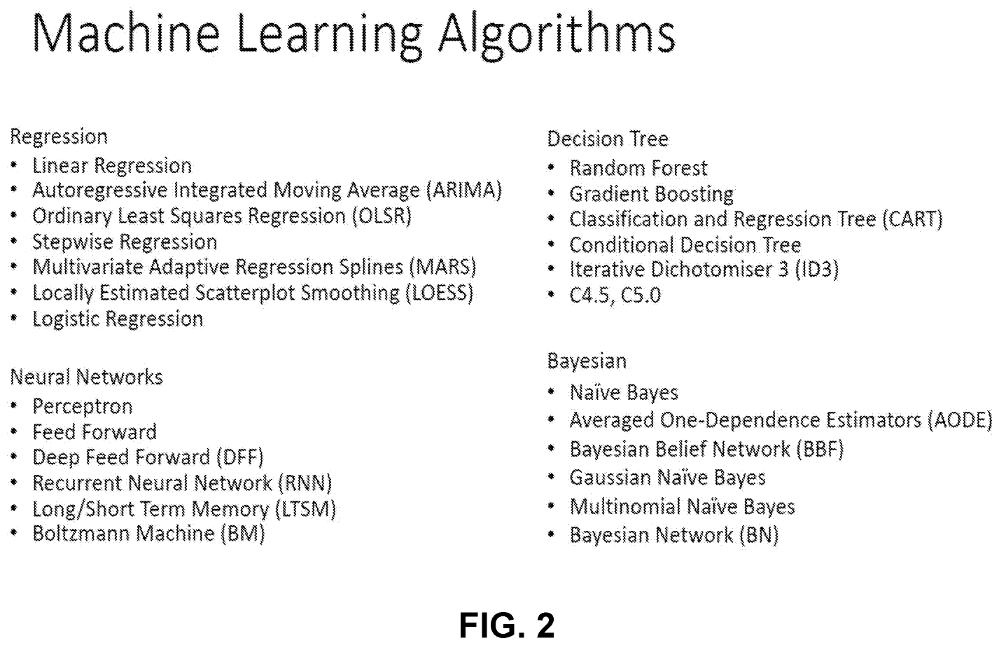

Models can be selected from a variety of machine learning algorithms 103 and a number of variations for each algorithm to build machine learning models 105. There are numerous machine learning models to choose from and each may include characteristics that are a better match with a particular dataset than other models. A chart displaying many known types of machine learning algorithms is depicted in FIG. 2. The model or type of model that may be suitable for one dataset or type of data may not be suitable for another. The described embodiments are responsive to different types of data and are adapted to select a machine learning model that is best suited to each unique dataset for providing demand forecast results with the highest accuracy, for example, or that satisfies another one of the various different user-configurable criteria provided to the system.

System 100 is configured to forecast demand at different locations. The best model or type of model for processing data may be different for the different types of locations. System 100 provides a framework for each location and each type of data and can be configured to automatically evaluate which is the best model among dozens of available models (for each location/category).

The system is also capable of forecasting demand to a level of granularity that includes the particular good, product, and/or service, and can be performed separately (e.g., using a separate machine learning model) for each specific location of the business or other entity. This yields a plurality of different machine learning models, each used separately for modeling the demand for each category of good, product or service offered by each unique location within the entity. Each dataset may contain data referring to different locations and/or categories of items. The system is enabled to select separate models and compute separate forecasts for each of these. In one embodiment a dataset may contain data for just one item category from one location.

For example, a coffee house chain may have three locations and the system can select an optimal machine learning model for each different type of coffee, pastry, or other product available at each of the different locations to yield multiple separate machine learning models for each item category for each location. The separate models can then be optimized using the techniques described herein. The demand results for each good, product and/or service available can then be aggregated to compute an overall demand forecast for each particular location of the coffee house. This information can be used to determine the number and qualifications of personnel needed for each category of tasks to be accomplished within each location of the coffee house chain. In other embodiments a dataset may include the data for each location and item category as a separate dataset, or any combination of these item categories and locations.

In the illustrated embodiment, system 100 includes a compute cluster 110 in communication with one or more data sources 102 over one or more interconnected computer networks 120. The compute cluster 110 is shown to comprise computer hardware servers 108 that each include a model (re-)training component 111, a model selection component 113, and a set of available machine learning algorithms 103 and corresponding set of machine learning models 105. In one embodiment, each of the machine learning models 105 correspond to a different (unique) configuration of the machine learning algorithms. One or more software modules run on the computer servers 108 with one or more datasets stored in the cluster 104 of database servers 106, which may be in communication with one another over the one or more networks 120. Network(s) 120 can be implemented in any wired or wireless network, including in a cloud network infrastructure.

Each compute server 108 in the compute cluster 110 is shown to include multiple different machine learning algorithms 103 and corresponding multiple different machine learning models 105. As used herein the term “a machine learning model” at least includes (1) a machine learning algorithm, (2) its set of corresponding parameters, and (3) the input dataset the machine learning algorithm was trained on. A model 105 may be generated using a dataset to train the model. In one embodiment, the parameters for the machine learning model may initially comprise a set of undefined parameters (not shown) used by the algorithm, which can be adapted to receive parameters values when a training dataset is applied to train the model to provide the values for the parameters. During training of a model using a dataset, the training data comprises at least a subset of a dataset. In one embodiment, for example, the dataset may be divided into a training set of data and a validation set of data, with the training set usually being larger than the validation set. For example the training data may comprise 60 percent of the dataset while the validation part of the dataset may be used to run the model once the model is trained on the training dataset.

System 100 may also be configured to be scalable to concurrently perform model selection for thousands of datasets, for example, and in a timeframe suitable for business applications. The compute servers 108 and the database servers 106 can be hosted in an environment that allows for servers to be added or removed from various clusters based on demand, such as in a commercial cloud-based network environment, allowing the system to scale in accordance with the size of the dataset(s) or other factors monitored by the system 100. The data sources 102 provide the data that is processed at the compute server 108. The processed data is stored in one or more of the datasets in database server(s) 106. The data sources 102 may be in communication with a database server 106 through computer network 120. Updates to the data can be received via this network. The data sources 120 may include point of sale (POS) systems that provide transaction data. In such embodiments, system 100 can be configured to integrate with various POS systems, e.g., from Square or Revel, to provide accurate and automated demand forecasting.

Similarly, one or more applications 112 that consume the selected models run on application servers 114 and receive output from the models via a direct communication channel 115 or over the network 120. Employee users and employers (e.g., administrators) may access the applications 112 on the system via network 120. In one embodiment, the system may be accessible via mobile wired or wireless devices with access to the network. User administrators may be provided with account information, such as login information that can be used to set up an account to access and configure the system for each business (or other entity) and for each of its different locations. Employers can login and configure to the system to receive demand forecasts and to generate employee work schedules that match the forecasted demand. In one embodiment the demand forecasts can be generated for 30-minute time increments for each product or service, or other such granularity that can be configured by users for the specific business or entity. Employees can login as well on, for example, a mobile wireless device or other computing device with access to the network. Employees can enter their work availability and other preferences and receive optimized schedules based on the employee preferences in accordance with the forecasted demand for the business for the scheduled time period.

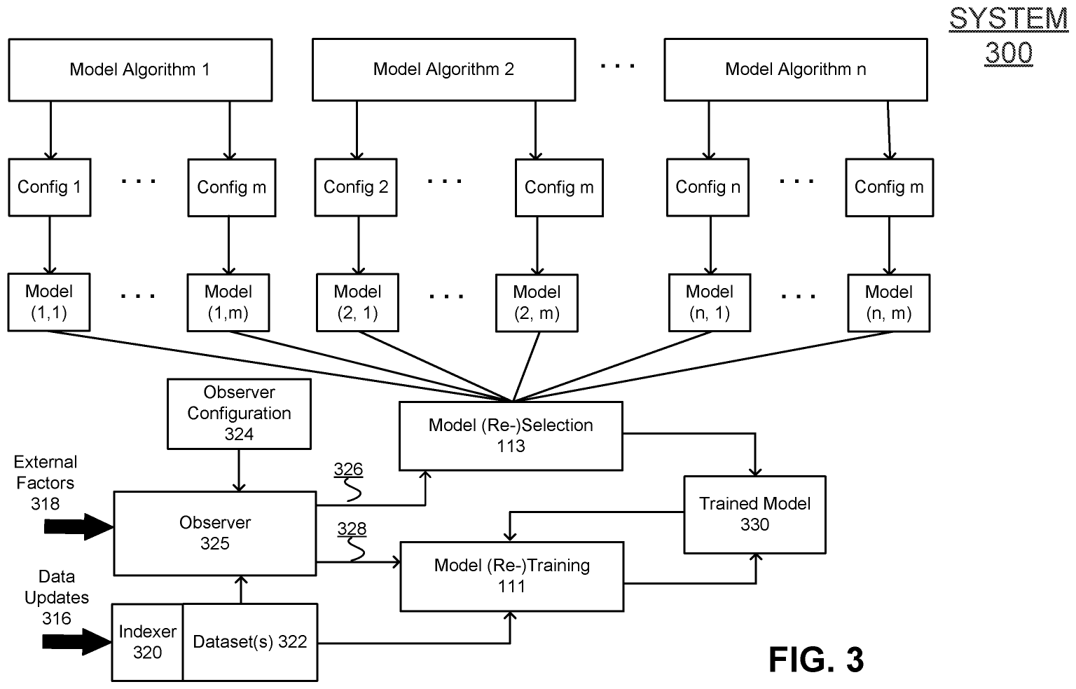

The machine learning models 105 can be selected from various machine learning algorithms 103 and variations within each algorithm. Model selection may occur automatically in response to change in the accuracy of the results, changes/updates to the dataset, and/or other external factors. The system can determine when and whether to select a new model or to retrain the currently selected model for optimal results. In other cases the currently selected model may already be providing the most accurate demand forecasts. In those cases the system determines not to initiate either a model retraining or reselection process. Further details of the model (re-) training component 111 and the model selection component 113 are described below in connection with FIG. 3 as they relate to the machine learning models and algorithms.

FIG. 3 depicts a conceptual block diagram of an example embodiment of a system for forecasting demand using automatic machine learning model selection according to the techniques described in this disclosure. System 300 may include some combination of the one or more servers 106, 108 and 114 as shown and described above with respect system 100 of FIG. 1, which may be identified according to the amount and/or type of data that is available for processing. In the illustrated embodiment, system 300 includes a machine learning model (re-)training component 111, a model (re-)selection component 113, an observer component 325, and one or more datasets 322. Raw data updates 316 can be received over one or more networks from one or more data sources (e.g., Square POS system data). The raw data can be indexed in an indexer 320 to generate one or more datasets 322. In one embodiment, the raw data updates 316 may be indexed into a plurality of time intervals to generate time series data. For instance, the raw data may be indexed into 30-minute time intervals so that the demand forecasts can be computed to obtain time series forecast results corresponding to each 30-minute time increment. Other granularities of time increments are possible and are configurable to the user's particular requirements. The indexed datasets 322 can then be used as the basis for selecting the appropriate machine learning model for demand forecasting.

In FIG. 3 the observer component 325 is shown to be in communication with the model (re-)training component 111 via direct or indirect connection 328 and in communication with the model (re-)selection component 113 via direct or indirect connection 326. The observer component 325 monitors changes in the dataset(s) 322 and other external factors 318 and based thereon determines whether to initiate a model retraining process via component 111 or a model reselection process via component 113. The observer configuration data structure(s) 324 may be adapted to store user-configurable settings for the system. The observer 325 can receive the user configuration settings stored in one or more observer configuration data structure(s) 324 and configure the system in accordance therewith.

In the first instance, the appropriate machine learning model may be selected and trained using a training dataset. The training dataset may be part of the dataset 322 to be processed, such as 60% as discussed above, while the remaining 40% of the dataset may be used to validate the model once it is trained. Other percentages of training data/processing data are possible since the process of training forecasting models using a set of training data is well known by persons of ordinary skill in the art. The trained model 330 can then be used to process subsequent data updates 316 received over the network(s) to compute demand forecasts using the trained model 330 (or to process new data received from a new data sources using the trained model 330). In one embodiment training model 330 may comprise applying at least a portion of the input data 316 to the selected model 330 to obtain values for the undefined parameters in the model. The trained model 330 can then be used to process the validation data for the dataset (e.g., 40% of the dataset).

Exemplary machine learning algorithms associated with each model are shown along the top of the diagram of the illustrated embodiment of system 300. Each of the modeling algorithms 1, 2 . . . n available on the system 300 can be associated with one or more different configurations (config 1-config m), (config 2-config m), and (config n-config m) for an array of multiple different machine learning models (1, 1) to (1, m), (2, 1) to (2, m), and (n, 1) to (n, m) as shown. In a preferred embodiment each machine learning model may comprise a machine learning algorithm and one of the different configurations for the machine learning algorithm. For each model algorithm, a range of configurations can be chosen to cover specific things that can be done with that particular model. The one or more different configurations (config 1-config m), (config 2-config m), and (config n-config m) may be stored in one or more files or data structures in the system to obtain a set of models that can be selected and trained/retrained by the system 300.

For every dataset and every location there are unique characteristics and thus different algorithms may be better suited to be the basis for a model depending on the dataset. In a preferred embodiment, each unique location and good, product and/or service within a business or other entity may be associated with its own machine learning model that is best suited for the corresponding dataset. For example the best machine learning algorithm for a particular dataset and location could be a “neural network” machine learning algorithm. In such a case there may be different configuration settings for the number of inputs, number of layers and number nodes, for example, to use with the neural network algorithm. Each layer may have a different number of nodes which can be configured in the configuration files/data structures. Configurations can also be used for determining what nodes are connected together in the algorithm or some specified subset of the nodes that are interconnected.

The observer unit 325 can be configured to continually monitor the incoming data updates 316 to the datasets 322 and to adjust the system 300 to utilize a machine learning model that is optimized for forecasting demand for each unique dataset 322. After the first instance where the model 330 is fully trained and busy processing data updates 316 for each dataset 322, the observer unit 325 can begin to evaluate the sufficiency of the results of the demand forecasts output by the selected trained model 330. In one embodiment, system 300 can include a feedback mechanism (not shown) in communication with the observer module 325 whereby the demand forecasts output by system 300 can be routed to the observer 325. The observer 325 can compare the demand forecasts output by the model 330 against the actual historical data once it is received to determine how accurate the demand forecast results were, and to adjust the machine learning model/algorithm in response thereto as appropriate. The observer unit 325 communicates with the model (re-)training component 111 via connection 328 to train/retrain the selected model 330 whenever the accuracy of the demand forecasts output by the model 330 falls to a specified level or threshold (or when the demand forecast satisfies some other user-configurable criteria). The level at which the tripping point is triggered can be configurable by users.

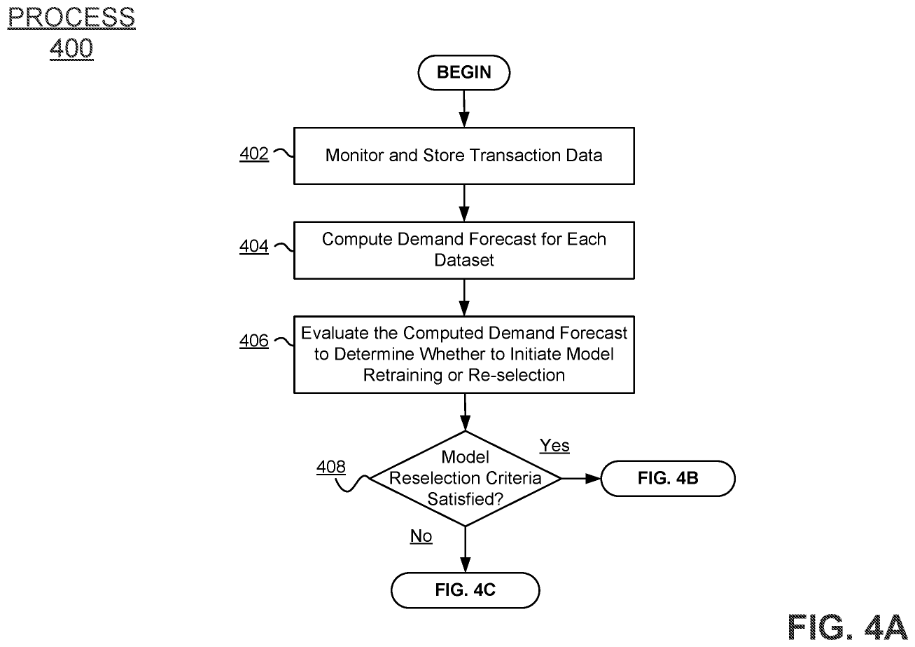

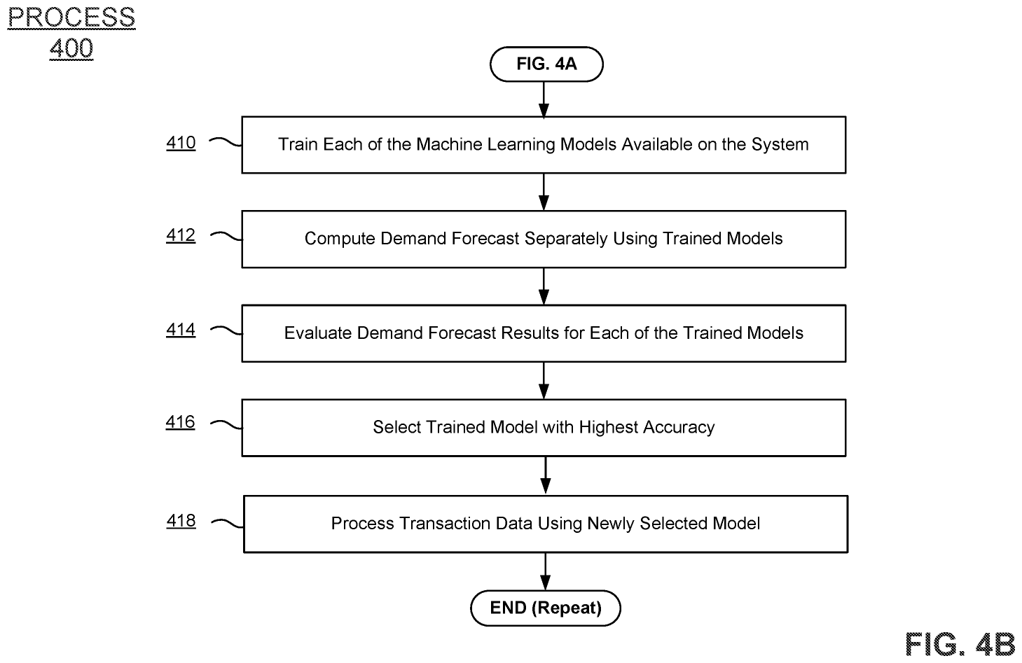

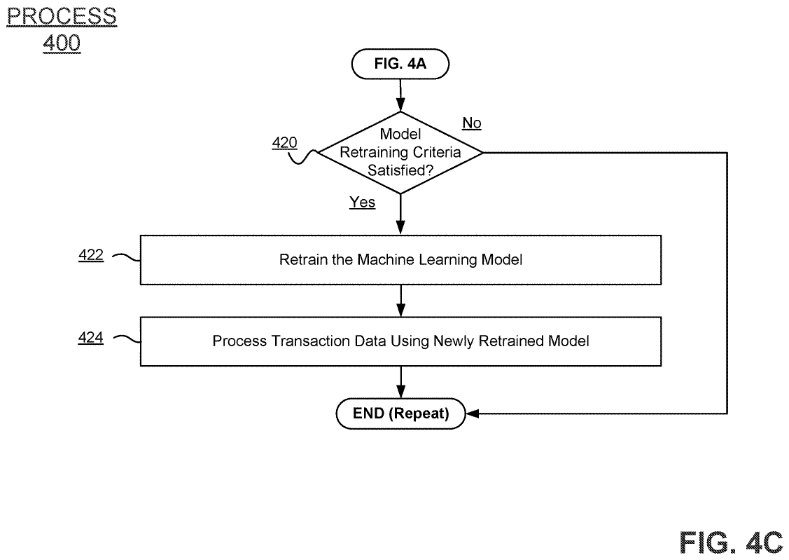

If the observer unit 325 determines that the currently selected model 330 needs to be trained/retrained, it can send a signal to the model (re-)training unit 111 via 328 and the currently selected model can thereafter be trained/retrained using a training data to obtain better results from the selected machine learning model 1-n. There are many user configurations that can be accounted for in this process. Observer 325 can be configured to trigger a training/retraining process based on these and other configurations. If on the other hand the observer unit 325 determines that the currently selected model 330 needs to be re-selected, either because the demand forecast result accuracy has dropped below a certain user-configurable threshold or based on some other factor(s), the observer 325 can send a signal to the model (re-)selection unit 113 via connection 326 to initiate the process of selecting a better machine learning model to process the data upon (or in some cases can determine that the currently selected model is the best available). The model reselection process is discussed in more detail below in connection with FIGS. 4A-4B infra.

Further, the observer unit 325 may determine that the demand forecast results output by the system 300 are acceptable and that training and/or model reselection are not required in a certain instance. This determination and its corresponding settings can be configured by users and provided to system 300, for example via the observer configuration data structure(s) 324. The observer 325 may also determine that the demand forecast results are unacceptable for failing to satisfy one or more configuration criteria.

### Example Processes

The following figures depict flow charts illustrating various example embodiments of a process for forecasting demand using automatic machine learning model selection in accordance with the techniques described in this disclosure. It is noted that the processes described below are exemplary in nature and are provided for illustrative purposes and are not intended to limit the scope of this disclosure to any particular example embodiment. For instance, processes in accordance with some embodiments described in this disclosure may include or omit some or all of the operations described below or may include operations in a different order than described. The particular processes described are not intended to be limited to any particular set of operations exclusive of all other potentially intermediate operations. In addition, the operations may be embodied in computer-executable code, which may cause a general-purpose or special-purpose computer processor to perform operations for providing demand forecasts. In other instances, these operations may be performed by specific hardware components or hardwired circuitry, or by any combination of programmed computer components and custom hardware circuitry.

FIG. 4A depicts a flow chart of an example embodiment of a process for forecasting demand using automatic machine learning model selection according to the techniques described in this disclosure. In at least certain embodiments process 400 may be implemented in a system that includes at least one computer hardware server comprising a network interface for communicating over a computer network and a memory for storing a plurality of different machine learning models adapted for computing a demand forecast. It should be noted that process 400 begins after a machine learning model has been previously selected and trained with a training dataset (not shown).

In the illustrated embodiment, process 400 monitors any new or updated transaction data received over one or more computer networks from one or more data sources and stores the data into one or more of a collection of datasets (operation 402). The demand forecast(s) can then be computed for each dataset in the collection (operation 404). The computed demand forecast results can thereafter be evaluated to determine whether to initiate a model retraining process or a model reselection process (operation 406). In one embodiment, the evaluation of the results may be based on comparing the computed demand forecast for the particular product and/or service with the actual demand that is obtained from historical data.

In embodiments the criteria for initiating a model retraining process or a model reselection process may be based on the accuracy of the demand forecast results provided by the model and/or based on other user-configurable criteria. For example a model retraining process or model reselection process may be initiated when the accuracy of the demand forecast results for a dataset falls below a preconfigured or predetermined threshold limit. The system can be configured to determine how accurate the forecasted results from the selected machine learning model are and to determine whether to initiate model retraining or reselection in response thereto. As discussed above, the system has the flexibility to discover the machine learning model that provides the best demand forecast results or that otherwise best fits with a particular dataset. The criteria can be configured by users according to their specific system requirements.

Process 400 continues to operation 408 where it is determined whether the model reselection criteria have been satisfied. For example, the reselection criteria may include determining when the accuracy of the demand forecast results falls below a preconfigured or predetermined threshold value.

If the criteria are satisfied for reselection of the machine learning model (for example to increase its accuracy or make it fit better with the input dataset, etc.), process 400 continues to operation 412 on FIG. 4B which depicts a flow chart of an example embodiment of a process for reselecting a machine learning model for forecasting demand according to the techniques described in this disclosure. Once the system determines that the criteria for model reselection has been satisfied, process 400 continues by training each of the plurality of different machine learning models available on the computer hardware server (or otherwise available to the computer hardware server via one or more network connections) for forecasting demand using the training data to build a plurality of different trained machine learning models (operation 410). A demand forecast for the transaction data for a dataset can then be computed separately for each of the different newly trained machine learning models available to the system (operation 412) and the resulting demand forecast results output from each of the models can be evaluated for accuracy for or for other user-configurable criteria (operation 414).

In one embodiment the evaluation can be performed based on comparing the actual demand from historical data with the forecasted demand results provided by each of the machine learning models to determine which of the available models produces the best demand forecast accuracy for the particular dataset (or is best suited in some other way for the dataset). The model that produces the best accuracy (or satisfies some other user-configurable criteria) can then be selected (operation 416) and used to thereafter process any updates to the dataset(s) (operation 418). In one embodiment, the machine learning model that provides a demand forecast with the highest accuracy is automatically selected or retrained based on continually evaluating updates to the transaction data received in real time from the data sources over the computer network(s).

If at operation 408 on FIG. 4A the criteria are not satisfied for initiating the model reselection on the other hand, process 400 continues as shown to FIG. 4C which depicts a flow chart of an example embodiment of a process for retraining a machine learning model for forecasting demand according to the techniques described in this disclosure. At operation 420 it is determined whether the criteria for initiating a model retraining process have been satisfied. For example, it may be determined that model retraining is needed to increase the accuracy of the selected model (or make it fit better with the input dataset, etc.). Once it is determined that the criteria for model retraining have been satisfied, process 400 continues to operation 422 where the process to retrain the currently selected model is initiated. In one embodiment, the selected model can be retrained using training data or portion thereof as discussed previously. Once the machine learning model has been retrained, the newly trained machine learning model may be updated in the system, and thereafter used for processing subsequent transaction data (operation 424).

As with model reselection, the criteria for retraining a currently selected machine learning model may include detecting a decrease in the accuracy of the demand forecast results provided by the model below a preconfigured or predetermined threshold amount. For example, the accuracy may only need to drop below 99% percent in some systems to initiate a model retraining process. Other values are possible and configurable by users. The threshold information can be predetermined or preconfigured based on user input. The threshold for initiating a model retraining process may differ from the threshold amount required for initiating a model reselection process or vice versa. In one embodiment, the threshold value for model reselection is less than the threshold value for model retraining and vice versa. For instance, model reselection may be appropriate whenever the accuracy of the demand forecast drops below 95%, whereas model retraining may be appropriate any time the accuracy of the demand forecast drops below 99%. As described, these various different thresholds and their various different arrangements are user configurable. In many cases model reselection is more expensive than model retraining in terms of utilization of computing resources, so typically model reselection will be initiated when model retraining is not effective at curing the problem.

Once the machine learning model forecast results been evaluated and either retrained or reselected, the newly trained or selected machine learning model may be updated in the system, and thereafter used for processing subsequent transaction data. In one embodiment, this process is configured to repeat as new data is received such that the machine learning algorithm is continually optimized to match with the new data and achieve the best results based on the configurations for the system. This completes process 400 according to one example embodiment.

The system may also be adapted to scale based on the number of datasets as the datasets and number of data sources change with time. Computer hardware servers can be added or removed from the system to accommodate changing datasets. In one embodiment the scaling can be configured to be accomplished in real time (or near real time), or within a preconfigured or user-configured timeframe that is acceptable for business applications.

In addition, a separate demand forecast may be generated for each unique good, product and/or service in the dataset and for each different location using a separate machine learning model for each. The data may also be divided into time slots or buckets as time series data. External factors can also be configured in computing an overall demand forecast. For example, the system may be able to take as inputs information relating to new sources of data or other externals such as sales, store traffic, seasonality, weather, nearby events, etc.

As examples, the machine learning algorithm may include a linear regression model, a neural network model, a random forest model, an auto regressive integrated moving average (“ARIMA”) model, a gradient boosting model, or other machine learning model known in the art such as the ones depicted in FIG. 2. Other models are possible as this field is constantly evolving. Also each different machine learning algorithm may be associated with a data structure that defines a range of different configurations based on the machine learning algorithm from which model selection will occur.

### Example Hardware Implementation

Embodiments of the present disclosure may be practiced using various computer systems including hand-held devices, microprocessor systems, programmable electronics, laptops, tablets and the like. The embodiments can also be practiced in distributed computing environments where tasks are performed by remote processing devices that are linked through one or more wire-based or wireless networks. A hardware module may be implemented mechanically, electronically, or any suitable combination thereof. A hardware module may include dedicated circuitry or logic that is permanently configured to perform certain operations. For example, a hardware module may be a special-purpose processor, such as a Field Programmable Gate Array (“FPGA”) or an Application Specific Integrated Circuit (“ASIC”), Programmable Logic Device (“PLD”), etc.

A hardware module may also include programmable logic or circuitry that is temporarily configured by software to perform operations. For example, a hardware module may include software executed by a general-purpose processor or other programmable processor. Once configured by such software, hardware modules may become specific machines (or specific components of a machine) tailored to perform one or more configured functions. It will be appreciated that the decision to implement a hardware module mechanically in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain of the operations described in this disclosure.

Similarly, the functions described in this disclosure may be at least partially processor-implemented, with a particular processor or processors being an example of hardware. For example, at least some of the operations of a function may be performed by one or more processors or processor-implemented modules. Moreover, the one or more processors may also operate to support performance of the relevant operations in a cloud computing environment or as software as a service (“SaaS”). In addition, at least some of the operations may be performed by a group of computers (as examples of machines including processors), with these operations being accessible via a network (e.g., the Internet) and via one or more appropriate interfaces (e.g., an API).

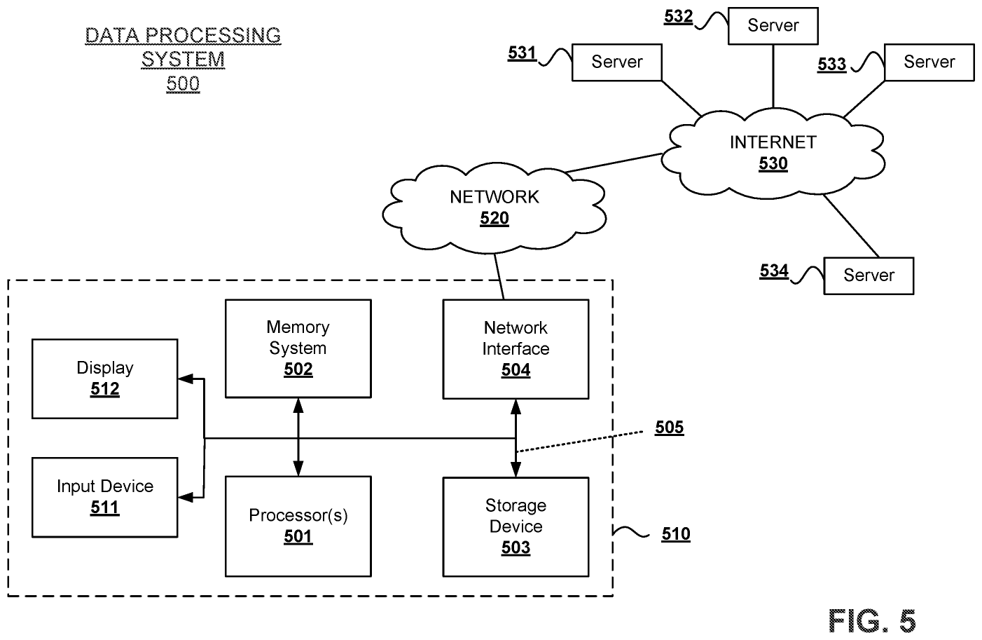

FIG. 5 depicts an example overview block diagram of a data processing system upon which the embodiments described in this disclosure may be implemented. It is to be understood that a variety of computers configurations may be used to implement the described techniques. While FIG. 5 illustrates various components of a data processing system 500, it is not intended to represent any particular architecture or manner of interconnecting components. It will also be appreciated that network computers and other data processing systems, which have fewer components or additional components, may be used. The data processing system 500 may, for example, comprise a personal computer (PC), workstation, laptop computer, tablet, smartphone or other hand-held wireless device, or any device having similar functionality.

In the illustrated embodiment, data processing system 500 includes a computer system 510. Computer system 510 includes an interconnect bus 505 (or other communication mechanism for communicating information) and one or more processor(s) 501 coupled with the interconnect bus 505 for processing information. Computer system 510 also includes a memory system 502 coupled with the one or more processors 501 via the interconnect bus 505. Memory system 502 is configured to store information and instructions to be executed by processor 501, including information and instructions for performing the techniques described above. This memory system may also be used for storing programs executed by processor(s) 501. Possible implementations of this memory system may be, but are not limited to, random access memory (RAM), read only memory (ROM), or combination thereof.

In the illustrated embodiment, a storage device 503 is also provided for storing information and instructions. Typically storage device 503 comprises nonvolatile memory. Common forms of storage devices include, for example, a hard drive, a magnetic disk, an optical disk, a CD-ROM, a DVD, a flash or other non-volatile memory, a USB memory card, or any other computer-readable medium from which a computer can read data and instructions. Storage device 503 may store source code, binary code, or software files for performing the techniques above. In addition, while FIG. 5 shows that storage device 503 as a local device connected with the components of the data processing system, it will be appreciated by skilled artisans that the described techniques may use a storage device remote from the system, such as a database or other network storage device coupled with the computer system 510 through a network interface such as network interface 504.

Network interface 504 may provide communications between computer system 510 and a network 520. The network interface 504 may be a wireless or wired connection, or any combination thereof. Computer system 510 is configured to send and receive information through the network interface 504 across one or more networks 520 such as a local area network (LAN), wide-area network (WAN), wireless or Bluetooth network, or the Internet 530, etc. Computer system 510 may access data and features on systems residing on one or multiple different hardware servers 531-534 across the network 520. Hardware servers 531-534 and associated server software may also reside in a cloud-computing environment.

Storage device and memory system are both examples of non-transitory computer readable storage media. Embodiments in this disclosure can be embodied in computer-readable code stored on any computer-readable medium, which when executed by a computer or other data processing system, can be adapted to cause the system to perform operations according to the techniques described in this disclosure. Computer-readable media may include any mechanism that stores information in a form accessible by a data processing system such as a computer, network device, tablet, smartphone, or any device having similar functionality. Examples of computer-readable media include any type of non-transitory, tangible media capable of storing information thereon, including floppy disks, hard drive disks (“HDDs”), solid-state devices (“SSDs”) or other flash memory, optical disks, digital video disks (“DVDs”), CD-ROMs, magnetic-optical disks, ROMs, RAMs, erasable programmable read only memory (“EPROMs”), electrically erasable programmable read only memory (“EEPROMs”), magnetic or optical cards, or any other type of media suitable for storing data and instructions in an electronic format. Computer-readable media can also be distributed over a network-coupled computer system stored and executed in a distributed fashion. Storage device 503 and memory system 502 are both examples of non-transitory computer readable storage media.

Further, computer system 510 may be coupled via interconnect bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized interconnect buses.

With these embodiments in mind, it will be apparent from this description that aspects of the described techniques may be embodied, at least in part, in software, hardware, firmware, or any combination thereof. It should also be understood that embodiments can employ various computer-implemented functions involving data stored in a computer system. The techniques may be carried out in a computer system or other data processing system in response executing sequences of instructions stored in memory.

This disclosure has been described in terms of the representative embodiments disclosed herein. The above example embodiments should not be deemed to be the only embodiments and are presented to illustrate the flexibility and advantages of the described techniques. Other embodiments, implementations, and/or equivalents will be evident to those skilled in the art and may be employed without departing from the spirit and scope of this disclosure as defined by the following claims.

What is claimed is:

1. A method comprising:
at a system with at least one computer hardware server comprising a network interface for communicating over a computer network and a memory for storing a plurality of different machine learning models adapted for computing a demand forecast:
monitoring new and updated transaction data received over the computer network from one or more data sources and storing the transaction data into one or more of a collection of datasets;
computing a demand forecast for the transaction data for each dataset in the collection using a selected one from among the plurality of different machine learning models available to the computer hardware server, wherein the selected machine learning model is trained using training data comprising at least a portion of the transaction data;
evaluating the accuracy of the computed demand forecast based on comparing the actual demand with the computed demand forecast;
determining for each dataset whether to initiate a reselection process for the selected machine learning model based on the accuracy of the demand forecast;
commencing reselection of the machine learning model when the accuracy of the demand forecast decreases below a first threshold value to obtain a reselected machine learning model;
updating the selected machine learning model with the reselected machine learning model; and
processing the transaction data using the updated machine learning model.

2. The method of claim 1 further comprising:
determining for each dataset whether to initiate a retraining process for the selected machine learning model based on the accuracy of the demand forecast;
retraining the machine learning model when the accuracy of the demand forecast decreases below a second threshold value to obtain a retrained machine learning model; and
updating the selected machine learning model with the retrained machine learning model and processing the transaction data using the updated machine learning model.

3. The method of claim 1 wherein reselection of the machine learning model comprises:
training each of the plurality of different machine learning models for forecasting demand using the training data to generate a plurality of different trained machine learning models;
computing a demand forecast for the transaction data using each of the different trained machine learning models available to the computer hardware server;
evaluating the accuracy of the demand forecast for each of the different machine learning models based on comparing the actual demand with the demand forecast; and
selecting one of the plurality of different trained machine learning models providing a demand forecast with highest accuracy.

4. The method of claim 2 wherein the machine learning model that provides a demand forecast with the highest accuracy is reselected or retrained based on continually evaluating updates to the transaction data received from the data sources over the computer network.

5. The method of claim 1 wherein each of the plurality of different machine learning models includes the input transaction data, a machine learning algorithm, and a plurality of undefined model parameters, and wherein the machine learning model is generated by applying the input transaction data to the machine learning algorithm, including assigning values to the plurality of undefined model parameters.

6. The method of claim 1 wherein the machine learning algorithm is selected from the group consisting of: a linear regression model; a neural network model; a random forest model; an auto regressive integrated moving average (“ARIMA”) model; and a gradient boosting model.

7. The method of claim 2 wherein each different machine learning algorithm is associated with a data structure that defines a range of different configurations based on the machine learning algorithm from which model selection will occur.

8. The method of claim 1 wherein a separate demand forecast is computed for each good, product and/or service using a separate machine learning model.

9. The method of claim 1 further comprising receiving external factors as inputs to the system in addition to the transaction data and computing a demand forecast based on the dataset in combination with the external factors.

10. The method of claim 1 wherein the system is adapted to scale based on the number and size of datasets as the transaction data and number of data sources change in time, the scaling including adding or removing computer hardware servers in the system within a preconfigured timeframe.

11. A system comprising:
a database in communication with the computer hardware server via the computer network, the database for storing transaction data into one or more of a collection of datasets,
at least one computer hardware server comprising a processor, a network interface for communicating over a computer network, and a memory for storing a plurality of different machine learning models adapted for computing a demand forecast, wherein the processor is configured to:
monitor new and updated transaction data received over the computer network from one or more data sources and storing the transaction data into one or more of a collection of datasets;
compute a demand forecast for the transaction data for each dataset in the collection using a selected one from among the plurality of different machine learning models available to the computer hardware server, wherein the selected machine learning model is trained using training data comprising at least a portion of the transaction data;
evaluate the accuracy of the computed demand forecast based on comparing the actual demand with the computed demand forecast;
determine for each dataset whether to initiate a reselection process for the selected machine learning model based on the accuracy of the demand forecast;
commence reselection of the machine learning model when the accuracy of the demand forecast decreases below a first threshold value to obtain a reselected machine learning model;
update the selected machine learning model with the reselected machine learning model; and
process the transaction data using the updated machine learning model.

12. The system of claim 11 wherein the processor is further configured to:
determine for each dataset whether to initiate a retraining process for the selected machine learning model based on the accuracy of the demand forecast;
retrain the machine learning model when the accuracy of the demand forecast decreases below a second threshold value to obtain a retrained machine learning model; and
update the selected machine learning model with the retrained machine learning model and processing the transaction data using the updated machine learning model.

13. The system of claim 11 wherein reselection of the machine learning model comprises:
training each of the plurality of different machine learning models for forecasting demand using the training data to generate a plurality of different trained machine learning models;
computing a demand forecast for the transaction data using each of the different trained machine learning models available to the computer hardware server;
evaluating the accuracy of the demand forecast for each of the different machine learning models based on comparing the actual demand with the demand forecast; and
selecting one of the plurality of different trained machine learning models providing a demand forecast with highest accuracy.

14. The system of claim 12 wherein the machine learning model that provides a demand forecast with the highest accuracy is reselected or retrained based on continually evaluating updates to the transaction data received from the data sources over the computer network.

15. The system of claim 11 wherein each of the plurality of different machine learning models includes the input transaction data, a machine learning algorithm, and a plurality of undefined model parameters, and

[symbol]

16. The system of claim 15 wherein the machine learning model is generated by applying the input transaction data to the machine learning algorithm, including assigning values to the plurality of undefined model parameters.

17. The system of claim 11 wherein the machine learning algorithm is selected from the group consisting of: a linear regression model; a neural network model; a random forest model; an auto regressive integrated moving average (“ARIMA”) model; and a gradient boosting model.

18. The system of claim 11 wherein the system is adapted to scale based on the number and size of datasets as the transaction data and number of data sources change in time, the scaling including adding or removing computer hardware servers in the system within a preconfigured timeframe.

19. The system of claim 11 wherein a separate demand forecast is computed for each good, product and/or service using a separate machine learning model.

20. A nontransitory computer readable storage medium adapted for storing programmed computer code executable by a processor in a computer hardware server to perform operations for computing a demand forecast, the operations comprising:
monitoring new and updated transaction data received over the computer network from one or more data sources and storing the transaction data into one or more of a collection of datasets;
computing a demand forecast for the transaction data for each dataset in the collection using a selected one from among the plurality of different machine learning models available to the computer hardware server, wherein the selected machine learning model is trained using training data comprising at least a portion of the transaction data;
evaluating the accuracy of the computed demand forecast based on comparing the actual demand with the computed demand forecast;
determining for each dataset whether to initiate a reselection process for the selected machine learning model based on the accuracy of the demand forecast;
commencing reselection of the machine learning model when the accuracy of the demand forecast decreases below a first threshold value to obtain a reselected machine learning model;
updating the selected machine learning model with the reselected machine learning model; and
processing the transaction data using the updated machine learning model.

21. The computer readable storage medium of claim 20 wherein the operations further comprise:
determining for each dataset whether to initiate a retraining process for the selected machine learning model based on the accuracy of the demand forecast;
retraining the machine learning model when the accuracy of the demand forecast decreases below a second threshold value to obtain a retrained machine learning model; and
updating the selected machine learning model with the retrained machine learning model and processing the transaction data using the updated machine learning model.

22. The computer readable storage medium of claim 20 wherein reselection of the machine learning model comprises:
training each of the plurality of different machine learning models for forecasting demand using the training data to generate a plurality of different trained machine learning models;
computing a demand forecast for the transaction data using each of the different trained machine learning models available to the computer hardware server;
evaluating the accuracy of the demand forecast for each of the different machine learning models based on comparing the actual demand with the demand forecast; and
selecting one of the plurality of different trained machine learning models providing a demand forecast with highest accuracy.
